(19) United States
(12) Patent Application Publication
(10) Pub. No.: US 2016/0286976 A1
(43) Pub. Date: Oct. 6, 2016

(54) Antimicrobial Treatment for Flocked PVC

(71) Applicant: The Coleman Company, Inc., Wichita, KS (US)

(72) Inventors: Huiqiang Yu, Jinshazhou (CN); Michael Maletta, Lafayette, CO (US)

(73) Assignee: The Coleman Company, Inc., Wichita, KS (US)

(21) Appl. No.: 15/088,424

(22) Filed: Apr. 1, 2016

Related U.S. Application Data
(60) Provisional application No. 62/141,476, filed on Apr. 1, 2015.

(51) Int. Cl. A47C 31/00; C08J 7/00; A47C 27/08; C09J 5/00

(52) U.S. Cl. CPC A47C 31/007; C09J 5/00; C08J 7/00; A47C 27/081; C08J 2327/06

(57) ABSTRACT

Flocked polyvinyl chloride (PVC) having an antimicrobial treatment wherein said treatment is applied to the PVC through the steps of first adding a selected antimicrobial agent into a flocking adhesive and thoroughly mixing the agent and adhesive, applying the adhesive containing the selected antimicrobial agent to the PVC material, and lastly applying selected flocking fibers to the side of the PVC material having the adhesive/antimicrobial agent coating.

### CROSS-REFERENCE TO RELATED APPLICATIONS

This application claims priority of U.S. Provisional Application Ser. No. 62/141,476 filed Apr. 1, 2015, which is incorporated herein by reference.

### BACKGROUND OF THE INVENTION

Inflatable air mattresses are commonly used in camping and other outdoor activities, as well as indoor activities, to provide added comfort when sleeping in a tent, on the ground, on a floor or other hard surface and to provide additional beds for guests. Inflatable air mattresses are easily transportable and relatively inexpensive, especially when compared to a conventional mattress. As is well-known in the art, inflatable air mattresses are traditionally made from polyvinyl chloride (PVC), a cost-efficient and durable material. As is also known in the art, the PVC may be flocked using known flocking methods to provide additional durability and comfort for the user. In addition to durability and comfort, consumers have shown interest in products having antimicrobial properties. As such, the goal of the present invention is to provide a process for applying an antimicrobial treatment to flocked PVC, specifically for use in manufacturing inflatable air mattresses.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description of some embodiments that are presented later.

In accordance with an embodiment, flocked PVC is created by first adding a selected antimicrobial agent into a flocking adhesive and thoroughly mixing the agent and adhesive; next by applying the adhesive containing the selected antimicrobial agent to the PVC material; and lastly by applying selected flocking fibers to the side of the PVC material having the adhesive/antimicrobial agent coating. The flocked PVC material having the antimicrobial coating may then be used to create products as is known in the art, including inflatable air mattresses and the like.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

A sheet of polyvinyl chloride material (PVC) manufactured according to methods commonly known in the industry is provided in either sheet or roll form. The thickness of the PVC material may vary depending on the intended end-use and such measurements are known by those in the industry.

An antimicrobial agent available in the industry is selected based on desired or necessary characteristics for the end-product. A flocking adhesive available in the industry is also selected based on the desired or necessary characteristics for the end-product. The selected antimicrobial agent is added into the selected flocking adhesive and is thoroughly mixed to create a paste.

The antimicrobial agent/flocking adhesive paste is applied to a first side of the sheet or roll of PVC material using techniques commonly known in the industry. Once the paste has been applied, flocking fibers are applied to the paste for adhesion to the first side of the PVC material. The specific flocking fibers used are selected based on the desired or necessary characteristics for the specific end-product. Similarly, the density of application of the flocking fibers will depend on the specific end-product and is not relevant for the present inventive method.

Once the flocking fibers have sufficiently dried and adhered to the PVC material, the PVC material may be used to create the desired end-product as is known in the art, including inflatable air mattresses and the like.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of adding an antimicrobial agent to a flocked polyvinyl chloride material, comprising the steps of:
Selecting a desired antimicrobial agent and thoroughly mixing said antimicrobial agent into a selected adhesive to create an adhesive/antimicrobial agent paste;
Applying said adhesive/antimicrobial agent paste onto a first side of a sheet of polyvinyl chloride material; and
Applying flock fibers to the first side of the sheet of polyvinyl chloride material having the adhesive/antimicrobial agent paste.

2. An inflatable air mattress made of flocked PVC made from the method of claim 1.
